(19) United States
(12) Patent Application Publication
(10) Pub. No.: US 2010/0159352 A1
(43) Pub. Date: Jun. 24, 2010

(54) PROCESS FOR PRODUCING ENERGY PREFERABLY IN THE FORM OF ELECTRICITY AND/OR HEAT USING CARBON DIOXIDE AND METHANE BY CATALYTIC GAS REACTION AND A DEVICE FOR PERFORMING THE PROCESS

(76) Inventors: Patrick Gelin, Montanay (FR); Marc Lambert, Langhus (NO); Erik Fareid, Langesund (NO); Tommy Schierning, Ski (NO)

Correspondence Address: FROMMER LAWRENCE & HAUG, 745 FIFTH AVENUE- 10TH FL., NEW YORK, NY, 10151, US

(21) Appl. No.: 12/663,186

(22) PCT Filed: Jun. 18, 2008
(86) PCT No.: PCT/NO2008/000222

§ 371 Date: Feb. 8, 2010

(30) Foreign Application Priority Data
Jun. 18, 2007 (NO) 20073080

(51) Int. Cl. H01M 8/10

(52) U.S. Cl. 429/488

(57) ABSTRACT

It is disclosed a process for producing electricity through the combustion of organic material, in said combustion there being formed carbon dioxide and carbon monoxide which is recycled and used as raw material. The reaction is performed in a combined catalytic gas reactor/membrane.

### DISCLOSURE

With today's focus on human-produced CO₂ and the effect this substance has on pollution and global heating, it is of great importance to reduce or re-use and recirculate CO₂.

It is previously known different materials and methods for methanation and production of hydrogen. Examples of such prior art is represented by the following publications:

Jianjun Guo, Hui Lou, Hong Zhao, Dingfeng Chai and Xiaoming Zheng: “Dry reforming of methane over nickel catalysts supported on magnesium aluminate spines” Applied Catalysis A: General, Volume 273, no. 1-2, 8. October 2004, page 75-82;

M. Wisniewski, A. Boréave and P. Gélin: “Catalytic CO₂ reforming of methane over Ir/Ce_{0.9}Gd_{0.1}O₂₋ₓ” Catalysis Communications, Volume 6, nbo. 9, September 2005, page 596-600;

Masaya Matsouka, Masaaki Kitano, Masato Takeuchi, Koichiro Tsujimaru, Masakazu Anpo and John M. Thomas: “Photocatalysis for new energy production. Recent advances in photo catalytic water splitting reactions for hydrogen production” Catalysis Today, 6. Mar. 2007;

U. (Balu) Balachandran, T. H. Lee and S. E. Dorris: “Hydrogen production by water dissociation using mixed conducting dense ceramic membranes” International Journal of Hydrogen Energy, Volume 32, no. 4, Mar. 2007, page 451-456;

Daniel M. Ginosar, Lucia M. Petkovic, Anne W. Glenn and Kyle C. Burch: “Stability of supported platinum sulfuric acid decomposition catalysts for use in thermo chemical water splitting cycles” International Journal of Hydrogen Energy, Volume 32, no. 4, March 2007, page 482-488;

T. Sano, M. Kojima, N. Hasegawa, M. Tsuji and Y. Tamaura: “Thermo chemical water-splitting by a carbon-bearing Ni(II) ferrite at 300° C.” International Journal of Hydrogen Energy, Volume 21, no. 9, September 1996, page 781-787;

S. K. Mohapatra, M. Misra, V. K. Mahjan and K. S. Raja: “A novel method for the synthesis of titania nano tubes using sono electro chemical method and its application for photo electro chemical splitting of water” Journal of Catalysis, Volume 246, no. 2, 10. March 2007, page 362-369;

S. K. Mohapatra, M. Misra, V. K. Mahajan and K. S. Raja: “A novel method for the synthesis of titania nano tubes using sono electro chemical method and its application for photo electro chemical splitting of water” Journal of Catalysis, Volume 246, no. 2, 10. March 2007, page 362-369;

Meng Ni, Michael K. H. Leung, Dennis Y. C. Leung and K. Sumathy: “A review and recent developments in photo-catalytic water-splitting using TiO₂ for hydrogen production”, Renewable and Sustainable Energy Reviews, Volume 11, no. 3, April 2007, page 401-425;

Wenfeng Shangguan: “Hydrogen evolution from water splitting on nano composite photo-catalysts” Science and Technology of Advanced Materials, Volume 8, no. 1-2, January-March 2007, page 76-81, APNF International Symposium on Nanotechnology in Environmental Protection and Pollution (ISNEPP2006);

Seng Sing Tan, Linda Zou and Eric Hu: “Photosynthesis of hydrogen and methane as key components for clean energy system” Science and Technology of Advanced Materials, Volume 8, no. 1-2, January-March 2007, page 89-92, APNF International Symposium on Nanotechnology in Environmental Protection and Pollution (ISNEPP2006);

U.S. Pat. No. 7,087,651 (Lee. Tuffnell et al., 8 Aug. 2006) “Process and apparatus for steam-methane reforming”;

U.S. Pat. No. 6,972,119 (Taguchi et al., Dec. 6, 2005) “Apparatus for forming hydrogen”;

U.S. Pat. No. 6,958,136 (Chandran et al., Oct. 25, 2005) “Process for the treatment of waste streams”;

U.S. Pat. No. 6,838,071 (Olsvik et al., Jan. 4, 2005) “Process for preparing a H₂-rich gas and a CO₂-rich gas at high pressure”.

The present invention may be summarized as a combined catalytic gas reactor including a catalyzer or process for combustion of fossil fuels/organic material, a catalyzer or process for creating hydrogen and oxygen by splitting of water, and a process with catalyzer or process for creating methane from reactions wherein CO, CO₂ and hydrogen participate according to a methanation reaction scheme as follows:

CO+H₂O═CO₂+H₂ 1.

CO+3H₂═CH₄+H₂O 2.

CO₂+4H₂═CH₄+2H₂O 3.

H₂O═H₂+½O₂ 5.

CH₄+2O₂═CO₂+2H₂O 6.

The combined complete process described above may be constructed as a Solid Oxide Fuel Cell (SOFC). In the above indicated reactions, the released energy of reactions 3 and 6 will substantially drive the water dissociation reaction according to equation 5.

In the present connection the concept “fossil fuel/organic material” is meant to be any combustible carbon-containing substance, e.g. any hydrocarbon and carbohydrate or derivatives thereof such as CH₄, C₂H₆, C₃H₈, C₂H₅OH, C₆H₁₂O₆, CO(CH₃)₂, CH₃CHO, CₙH₂ₙ₋₂ (wherein n is an integer), etc.

The oxidation or combustion of fossil fuels (reaction 6, here symbolized by Methane, CH₄), takes place over a catalyst suited for the reaction. This catalyst may consist of:
Pd (palladium)
Pt (platinum)
A combination of Pd and a co-metal taken among noble metals (for example Pt, Ir, . . . )
Perovskites (ABO₃) where for example A=La and B═Mn, Co, Fe, Ni
Substituted perovskites (AA′BO₃) with for example A=La, A′=Sr, Ce, Ag, and B═Mn, Co, Fe
Spinels such as for example CoCr₂O₄
Hexaaluminates such as for example La₁₋ₓMnₓAl₁₁O₁₉ (Mn-substituted La hexaaluminate)

Supports of metal catalysts may be for example:

Al₂O₃ (alumina), ZrO₂ (zirconia), CeO₂—Al₂O₃ (Al₂O₃ supported CeO₂), CeO₂₋ₓ—Al₂O₃ (Al₂O₃ supported non stoichiometric ceria), La-stabilized Al₂O₃, Y stabilized ZrO₂

The water is split into hydrogen and oxygen according to reaction 5 with thermo chemical membranes/catalysts. Some of these may be:
Membrane process at 200-900° C. (thermo chemical),
   Cerium oxide based membranes
   Perovskite based membranes

The membranes may be coated by metals to increase activity in the temperature interval 150 to 600° C., such as;
Ru (ruthenium) catalyst
Cu (copper) catalyst
Pt (platinum)
Rh (rhodium)
Ir (iridium)
Ag (silver)
Co (cobalt)
W (tungsten)
All other catalysts alone or together with one or more of the metals mentioned supra.

The methanation reaction may be performed with the catalysts infra with different compositions depending on the condition of the gas that is to be treated, but all methanation catalysts may be used in the temperature interval 150 to 600° C.;
Ni/NiO (nickel/nickel oxide) catalyst
Raney Ni catalyst
Ru (ruthenium) catalyst
Cu (copper) catalyst
Pt (platinum)
Rh (rhodium)
Ir (iridium)
Ag (silver)
Co (cobalt)
W (tungsten)
Cr (chromium)
VOₓ (vanadium oxide)
molybdenum carbide and nitride
All other catalysts alone or together with one or more of the metals mentioned supra.

These catalysts are deposited on a support such as for example:
Al₂O₃ (alumina)
TiO₂
SiO₂ (silica)
zeolites (e.g. Y)
ZrO₂, etc. . . .

The advantage of the present invention is that CO₂ is transformed to methane through the aid of hydrogen and may consequently be used again as a fuel or as a raw material for a number of other processes. Some of these processes may be the production of methane, methanol, ammonia, urea, nitrous acid, ammonium nitrate, NPK, PVC, etc.

The present invention may be used in all forms of exhaust gases wherein fossil or biological fuel is used.

In addition the structure and composition of the reactors and catalyzers according to the present invention solves the problem with emission of VOC (volatile organic compounds), NOx (nitrogen oxides), N₂O (laughing gas), NH₃ (ammonia) and other greenhouse and in other ways polluting gases.

The present invention produces also energy far more effectively than similar processes today, and has far lower CO₂ emission per kWh than contemporary processes with CO₂ harvesting. Other advantages of the present process versus others are apparent from table 1 infra.

TABLE 1
Comparison between the present invention and similar power
plants with and without CO₂ collection. All numbers* are relative
to today's without CO₂ collection and are expressed as a percentage
of the rates (considered as 100%) related to the contemporary process
without CO₂-colleciton:

| | Contemporary | Contemporary | The |
|---|---|---|---|
| | without | with | present |
| | CO₂-collection | CO₂-collection | invention |
| Investment | 100 | 225 | 100 |
| CO₂-emission | 100 | 15 | 10 |
| Fuel consumption | 100 | 120 | 5 |
| Fuel cost | 100 | 100 | 100 |
| CO₂ tax | 100 | 100 | 100 |
| CO₂ tax | 100 | 15 | 3.7 |
| Fuel cost | 100 | 120 | 2.1 |
| Financial cost | 100 | 232.6 | 100 |
| Totoal cost | 100 | 106.4 | 22.5 |

*All numbers are guiding

As a consequence of the development of the present invention, and as a non-separable part thereof, the present invention may be used within the general area of CO₂ purification, collection and sequestering.

The present invention is expressed as a reactor concept providing the industrial way of controlling the physical and chemical parameters involved in the following reaction equations:

| | | | |
|---|---|---|---|
| CO + H₂O = | CO₂ + H₂ | Shift reaction | 1. |
| CO + 3H₂ = | CH₄ + H₂O | Methanation reaction | 2. |
| CO₂ + 4H₂ = | CH₄ + 2H₂O | Methanation reaction | 3. |
| CO₂ + H₂ = | CO + H₂O | Reverse shift reaction | 4. |
| H₂O = | H₂ + ½ O₂ | Water splitting | 5. |
| CH₄ + 2 O₂ = | CO₂ + 2 H₂O | Combustion reaction | 6. |

The present reactions are also disclosed as the application of specific reactor designs providing catalytic and physical characteristics allowing and emphasizing the hydrogenation of CO₂ to CH₄ (methane).

The present invention may be considered as a tipple process with one part combusting fossil fuel by reaction 6, and with second part producing hydrogen and oxygen according to reaction 5. The total process may take advantage of the produced hydrogen from the first part, but may also individually produce hydrogen from reaction 1. In the third part the produced hydrogen will react with CO and CO₂ according to reaction 2 and 3 and produce methane. The produced methane and oxygen may either be re-circulated and combusted in a continuous loop or the methane and oxygen may be separated out and be used as a raw material for producing other chemicals.

Part 1 of the present invention may contain catalysts and other device making it possible to combust the fossil fuel completely (reaction 6).

Part 2 of the present invention may contain catalysts and other devices making it possible to use both the produced hydrogen and the produced oxygen (reaction 5).

Part 3 of the present invention is to contain a catalyst being suited for performing the methanation reaction, reactions 2 and 3, and suppressing the reverse shift reaction, reaction 4.

Part 1, 2 and part 3 may be integrated with each other or may be separate entities.

When all the parts are integrated into a Solid Oxide Fuel Cell (SOFC), the system will have the highest conversion efficiency because the energy in the fuel will be transformed directly into electrical energy rather than first being transformed into vaporization energy, further into mechanical energy thus producing electricity. The electrical efficiency will be higher than 90%.

Part 1 consists in performing the complete oxidation of fuel for thermal energy production. This energy is required for the endothermic section (part 2). A catalyst will be used for this step. The basic principle of catalytic combustion is to permit the combustion reaction to take place on or near the catalyst surface instead of in a flame. The activation energy required is much decreased compared to flame combustion so that combustion can proceed at much lower temperatures than in a flame. The formation of NOx is thus avoided. The emissions of unburnt CO and hydrocarbons is also much reduced. Catalytic combustion is a clean process. Other advantages are the increased stability of the combustion and the ability to combust fuels outside the flammability limits. A wide range of fuel/ratios can be used.

Since high temperatures may be reached during the process, the thermal stability of the catalyst is a major requirement for durability reasons. Basically, two classes of catalysts can be used for catalytic combustion: noble metals (Pd is the most active for CH₄ combustion) and metal oxides. The former catalysts are the most active but also the most expensive. In spite of their lower catalytic activity, the latter catalysts offer a good alternative to noble metals due to their much lower price and good thermal stability. Among them, perovskites and substituted hexaaluminates are the most promising ones, since offering a good compromise between activity and thermal stability.

Part 2 is the section wherein the water splitting is performed. This water dissociation needs much energy to happen. This energy may be taken from part 1 and/or part 3 developing large amounts of energy or the energy may be provided from external sources.

Membrane process at 200-900° C. (thermo chemical),
Cerium oxide based membranes
Perovskite based membranes

The membranes may be coated by metals to increase activity in the temperature interval 200 to 900° C., such as;
Ru (ruthenium) catalyst
Cu (copper) catalyst
Pt (platinum)
Rh (rhodium)
Ir (iridium)
Ag (silver)
Co (cobalt)
W (tungsten)
All other catalysts alone or together with one or more of the metals mentioned supra.

In Part 3 the transforming of CO₂ with hydrogen to methane is performed in a reactor with a catalyst. The heat being developed may be used for heating part 1 or in any other way. The shape of the catalyst is not essential and may inter alia comprise coated monoliths, different nano materials and other types and forms of carriers. The carriers may be selected from e.g. TiO₂, Al₂O₃, cordierite, Gd-doped CeO₂, perovskites and other types of carrier materials. The catalytic material may also be present in any form as a “pure” catalyst material. The form and composition of the reactor and the catalyst will depend on which emission gas it is wanted to purify. An impure exhaust gas with large amounts of dust (from the combustion of coal) may have a monolithic catalyst carrier whereas a pure exhaust gas (from a natural gas turbine) may have a catalyst in the form of pellets. All types of exhaust gases from all types of combustions of organic material may be treated.

The methanation reaction may be performed with the catalyzers infra with different compositions depending on the condition of the gas that is to be treated, but all methanation catalyzers may be used in the temperature interval 200 to 600° C.:
Ni/NiO (nickel/nickel oxide) catalyst
Ru (ruthenium) catalysts
Cu (copper) catalysts
Pt (platinum)
Rh (rhodium)
Ag (silver)
Co (cobalt)
W (tungsten)
All other catalysts alone or together with one or more of the metals mentioned supra.

When re-circulating the methane for further combustion and production of electricity or other forms of energy, the oxygen having been produced at the splitting of water may be used as a source for oxygen for the combustion of methane. Since air is not used as a source for oxygen, nitrogen will not participate as a diluting and reacting gas. Instead of nitrogen as a diluting gas (inert gas), water and CO₂ being produced at the combustion may be used. This gas (CO₂ and water) will be taken out for recirculation prior to the reactors having been disclosed in the present invention, and thus keeps a combustion temperature being commensurate with the materials that are present today for the construction of such combustion plants.

Nitrogen is the source for NOx at the combustion, and by performing the suggested recirculation the nitrogen will be replaced by CO₂ and water thereby avoiding the production of NOx. In avoiding NOx it is also possible to avoid the use of reducing measures creating laughing gas (N₂O).

Another theoretical solution for the use of the formed methane may be to produce methanol. This production may conceivably happen according to commercial processes being available today, and the methanol may have several areas of use such as e.g. fuel for transport means.

This process may conceivably be solved in the following way: Fuel is combusted with air in a burner. Electricity, optionally another form of energy, is taken out from the combustion process in the usual way. The CO₂ produced is used, as disclosed in the present invention, for producing methane. The methane is separated from the other gases and is used for producing methanol.

The present invention is not limited to these two fields, but may be used in all processes wherein natural gas or other hydrocarbons and organic compounds are one of the raw materials.

The present invention also produces energy far more efficiently than comparable processes today, and has a far lower CO₂ emission per kWh than today's processes with capture of CO₂. The other advantages of the present process as compared to others are observed in table 1 infra.

TABLE 1
Comparison between the present invention and comparable
power plants with and without capture of CO₂. All numbers a relative
to today's without capture of CO₂ expressed as a percentage,
taking the contemporary process as 100%:

| | Contemporary | Contemporary | The |
|---|---|---|---|
| | without | with | present |
| | CO₂-collection | CO₂-collection | invention |
| Investment | 100 | 225 | 100 |
| CO₂-emission | 100 | 15 | 10 |
| Fuel consumption | 100 | 120 | 5 |
| Fuel cost | 100 | 100 | 100 |
| CO₂ tax | 100 | 100 | 100 |
| CO₂ tax | 100 | 15 | 3.7 |
| Fuel cost | 100 | 120 | 2.1 |
| Financial cost | 100 | 232.6 | 100 |
| Totoal cost | 100 | 106.4 | 22.5 |

All numbers are guiding

A small part of the exhaust gas must be emitted to avoid accumulation of certain trace elements. This exhaust gas contains mainly of CO₂ and water. This composition makes it very simple to capture CO₂ without using chemicals (e.g. amines and others), since the water may be condensed out while the CO₂ still is in a gaseous state. CO₂ may then be used for other purposes or may be stored. The cost for capture and optionally storage then become very small.

The disclosed reactions are common reactions (equilibrium reactions) happening in the production of ammonia over different catalytic layers.

The shift reaction happens in the LT or HT shift reactor wherein carbon monoxide reacts to produce carbon dioxide and hydrogen over a iron oxide/chromium oxide respectively a copper oxide/zinc oxide catalyst.

The methanation reaction happens in the methane reactor wherein carbon monoxide and carbon dioxide is reacted into methane and water over a nickel, ruthenium, tungsten or other metal-containing catalyst according to several total reactions (equilibrium reactions), inter alia:

CO+H₂O═CO₂+H₂ 1.

CO+3H₂═CH₄+H₂O 2.

CO₂+4H₂═CH₄+2H₂O 3.

Since the ammonia process is a process for producing ammonia via hydrogen from methane and nitrogen from air, the reactions 2. and 3. disclosed supra are reactions that are not wanted and which give losses of in the production of ammonia.

In the present invention all of these reactions are wanted since they produce methane being a product or intermediates participating in producing methane, and this effect has not previously been disclosed in the patent literature.

The source of carbon dioxide may be all kinds of combustion of organic materials such as emission gases or combustion gases from power plants, boats, cars, industrial plants that also include other contaminants. These contaminants may be, but are not limited to N₂O, NO, NO₂, volatile compounds (VOCs), SO₂, etc.

Ordinary destruction of these contaminants happens with CO₂ present in the combustion gas. An ordinary concentration of CO₂ in the combustion gas is about 1-20% by volume. When CO₂ is removed prior to the other contaminants the catalyst volume and the addition of chemicals will be reduced dramatically, partly on account of the lowered volume, and partly on account of the inhibitor effect of CO₂ if this is present.

Any process solution may be used for removing these contaminants.

The invention may be summarized by the following items:

The present invention may be summarized as a combined catalytic gas reactor including a catalyzer or process for combustion of fossil fuels, a catalyzer or process for creating hydrogen and oxygen by splitting of water and a process with catalyzer or process for creating methane from reactions wherein CO, CO₂ and hydrogen participate according to a methanation reaction scheme as follows:

CO+H₂O═CO₂+H₂ 1.

CO+3H₂═CH₄+H₂O 2.

CO₂═4H₂═CH₄+2H₂O 3.

H₂O═H₂+½O₂ 5.

CH₄+2O₂═CO₂+2H₂O 6.

The combined complete process described above may be constructed as a Solid Oxide Fuel Cell (SOFC)

### General Use of the Invention.

The embodiments of the SOFC are directed both towards new uses and reconstruction of existing devices for industrial combustion, and the invention of these rebuilding applications and new installations are claimed.

### BRIEF ACCOUNT OF THE FIGURES

FIG. 1: SOFC Catalytic CO₂ recirculation (CCR) technology;

### DETAILED DISCLOSURE OF THE FIGURES

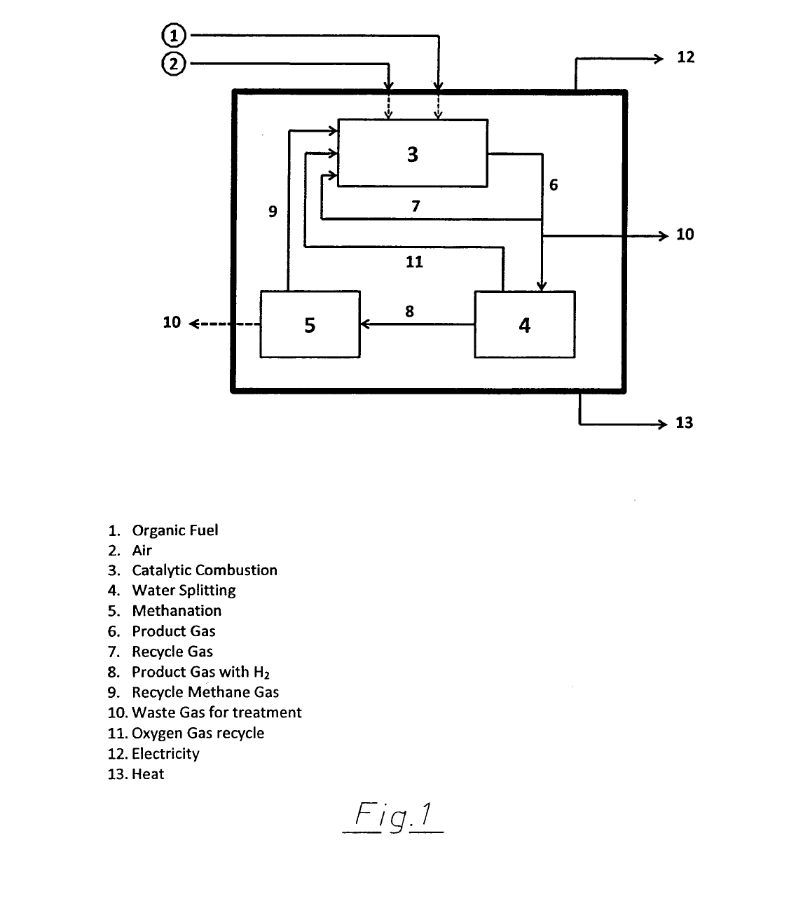

FIG. 1. The figure shows schematically the SOFC-CCR technology in any power-producing plant based on fossil/organic fuel. Organic fuel (1) is mixed with air (2) and combusted over a catalyst (3). The product gas (6) consisting of water (H₂O), Carbon-di-oxide (CO₂) and other gases may be recirculated and used as inertgas (7) in the combustion or emitted/treated outside the cell (10). The remaining gas is treated in the Water Splitter (4) where the remaining energy is used to split water into hydrogen (H2) and Oxygen (O2). The oxygen may be, at least partly, recycled (11) to the combustion and used together with the recycled water and carbon-di-oxide instead of air. The product (8) gas containing hydrogen (H2) is reacted in the methanation reactor (5) and recycled (9) to the combustion (3). The cell will produce electricity (12) at high efficiencies and/or heat (13).

If there is CO₂ in the purge gas (10), it may be compressed and stored in a suitable way.

### Example 1

During normal combustion in a standard type power plant, the electrical efficiency is around 35% because of different mechanical and condensation losses. This mean that the relative carbon-di-oxide emission will be around 2.9 rel/kWh.

### Example 2

The new process will have a much higher electrical efficiency because the chemical energy is directly transformed to electricity. The electrical efficiency may be as high as 95%. This means that the relative carbon-di-oxide emission will be around 1.1 rel/kWh. In all examples air or reintroduced CO₂, water and oxygen can be used as a combustion gas.

Aspects of the invention include a process for combustion of organic material/fossil fuel by using oxygen, wherein at least formed carbon monoxide (CO) and carbon dioxide (CO₂) and water (H₂O) is passed into a three-step catalytic gas reactor wherein said gas reactor in its first step includes a catalyst/membrane for the combustion of organic material/fossil fuel (reaction 6), in its second step a catalyst/membrane forming hydrogen and oxygen by dissociating water (through reaction 5), and in its third step a catalyst forming methane from reactions wherein CO, CO₂ and hydrogen participate according to a methanation scheme through reactions 2 and 3 as follows:

CO+H₂O═CO₂+H₂ 1.

CO+3H₂═CH₄+H₂O 2.

CO₂+4H₂═CH₄+2H₂O 3.

H₂O═H₂+½O₂ 5.

CH₄+2O₂═CO₂+2H₂ 6.

Further aspects of the process according to the invention include that at least parts of the hydrogen being formed at the reaction between carbon monoxide and water is returned to the third step of the reactor for the forming of methane, that the process is performed without any addition of nitrogen-containing gas (such as air) for avoiding the forming of nitrogen oxides, that the process is performed by parts or all of the formed oxygen at the dissociation of water being passed back to the first step for the combustion of the organic material, that the process is performed by parts or all of the formed water and the carbon dioxide is used as inert gas in step 1, that parts or all of the formed methane is used as starting material for other processes, that the formed oxygen is used as a starting material for other processes, that the formed CO₂ in the exhaust gas being emitted is caught and stored, that the formed CO₂ in the exhaust gas being emitted is caught and used in other connections, and that any step separately or collectively, including the combustion of the organic material, the water-splitting and/or the methanation reaction is/are performed at a temperature in the interval 200-1000° C., more preferred 250-850° C., most preferred 350-650° C.

Furthermore, the present invention includes a solid oxide fuel cell (SOFC) reactor, comprising three steps separately performing the reactions combustion of organic material/fossil fuel by using oxygen, wherein at least formed carbon monoxide (CO) and carbon dioxide (CO₂) and water (H₂O) is passed into a three-step catalytic gas reactor wherein said gas reactor in its first step includes a catalyst/membrane for the combustion of organic material/fossil fuel (reaction 6), in its second step a catalyst/membrane forming hydrogen and oxygen by dissociating water (through reaction 5), and in its third step a catalyst forming methane from reactions wherein CO, CO₂ and hydrogen participate according to a methanation scheme through reactions 2 and 3 as follows:

CO+H₂O═CO₂+H₂ 1.

CO+3H₂═CH₄+H₂O 2.

CO₂+4H₂═CH₄+2H₂O 3.

H₂O═H₂+½O₂ 5.

CH₄+2O₂═CO₂+2H₂O 6.

Such a solid oxide fuel cell (SOFC) reactor may in any step of the reactor be operated separately or collectively, including the combustion of the organic material, the water-splitting and/or the methanation reaction, at a temperature in the interval 200-1000° C., more preferred 250-850° C., most preferred 350-650° C.

1. Process for producing electricity by combustion of organic material/fossil fuel by using oxygen-containing gas,
wherein at least formed carbon monoxide (CO) and carbon dioxide (CO2) and water (H2O) is passed into a combined three-step catalytic gas reactor wherein said gas reactor in its first step includes a catalyst/membrane for the combustion of organic material/fossil fuel (reaction 6), in its second step a catalyst/membrane forming hydrogen and oxygen by dissociating water (through reaction 5), and in its third step a catalyst forming methane from reactions wherein CO, CO2 and hydrogen participate according to a methanation scheme through reactions 1, 2 and 3 as follows:
CO+H2O═CO2+H2 1.
CO+3H2=CH4+H2O 2.
CO2+4H2=CH4+2H2O 3.
H2O═H2+½O2 5.
CH4+2O2=CO2+2H2O 6.

2. Process according to claim 1,
wherein at least parts of the hydrogen being formed at the reaction between carbon monoxide and water is returned to the third step of the reactor for the forming of methane.

3. Process according to claim 1,
wherein it is performed without any addition of nitrogen-containing gas (such as air) for avoiding the forming of nitrogen oxides.

4. Process according to claim 1,
wherein it is performed by parts or all of the formed oxygen at the dissociation of water is passed back to the first step for the combustion of the organic material.

5. Process according to claim 1,
wherein it is performed by parts or all of the formed water and the carbon dioxide is used as inert gas in step 1.

6. Process according to claims 1,
wherein parts or all of the formed methane is used as starting material for other processes.

7. Process according to claim 1,
wherein the formed oxygen is used as a starting material for other processes.

8. Process according to claim 1,
wherein the formed CO2 in the exhaust gas being emitted is caught and stored.

9. Process according to claim 1,
wherein the formed CO2 in the exhaust gas being emitted is caught and used in other connections.

10. Process according to claim 1,
wherein any step separately or collectively, including the combustion of the organic material, the water-splitting and/or the methanation reaction is/are performed at a temperature in the interval 200-1000° C., more preferred 250-850° C., most preferred 350-650° C.

11. Solid oxide fuel cell (SOFC) reactor,
wherein it comprises inside an enclosure three steps (3, 4, 5) following in succession in the direction of the gas flow and performing combustion of organic material/fossil fuel by using oxygen-containing gas, wherein formed carbon monoxide (CO) and carbon dioxide (CO2) and water (H2O) from the combustion process is passed into the three-step catalytic gas reactor, said gas reactor in its first step (3) including a catalyst/membrane for the combustion of organic material/fossil fuel (reaction 6), in its second step (4) a catalyst/membrane forming hydrogen and oxygen by dissociating water (through reaction 5), and in its third step a catalyst forming methane from reactions wherein CO, CO2 and hydrogen participate according to a methanation scheme through reactions 2 and 3 as follows:
CO+H2O═CO2+H2 1.
CO+3H2=CH4+H2O 2.
CO2+4H2=CH4+2H2O 3.
H2O═H2+½O2 5.
CH4+2O2=CO2+2H2O 6
and wherein conduits from second step (4) and third step (5) return produced oxygen from the second step (4) and produced methane in the third step (5) into the entrance of the first step (3).

12. Solid oxide fuel cell (SOFC) reactor according to claim 11,
wherein any step (3, 4, 5) of the reactor has a temperature in the interval 200-1000° C., more preferred 250-850° C., most preferred 350-650° C.
